(19) United States
(12) Patent Application Publication
(10) Pub. No.: US 2002/0155054 A1
(43) Pub. Date: Oct. 24, 2002

(54) Highly resistive recrystallized silicon carbide, an anti-corrosive member, a method for producing the highly resistive recrystallized silicon carbide, and a method for producing the anti-corrosive member

(75) Inventors: Yasufumi Aihara, Sunneyvale, CA (US); Katsuhiro Inoue, Ama-Gun (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/109,090

(22) Filed: Mar. 28, 2002

Related U.S. Application Data
(62) Division of application No. 09/333,201, filed on Jun. 15, 1999.

(30) Foreign Application Priority Data
Jun. 23, 1998 (JP) 10-175,942

(51) Int. Cl. C01B 31/36

(52) U.S. Cl. 423/345

(57) ABSTRACT

A highly resistive recrystallized silicon carbide having open pores, wherein layered carbons on the inner wall surfaces of said open pores are removed and a resistivity at room temperature of said recrystallized silicon carbide is not less than 10000 Ω·cm.

### CROSS REFERENCE TO RELATED APPLICATION

This application is a division of U.S. Application Ser. No. 09/333,201, filed Jun. 15, 1999, the entirety of which is incorporated herein by reference.

### BACKGROUND OF THE INVENTION

1. Field of the Invention

This invention relates to a highly resistive recrystallized silicon carbide material having a relatively high electric resistance, a method for producing the same, and an anti-corrosive member utilizing the same.

2. Related Art Statement

Recrystallized silicon carbide normally exhibits low volume resistivity of about 0.1 Ω·cm to 50 Ω·cm at low temperatures under 500 ° C., and does not typically exhibit semiconductor characteristics. Thus, uses of recrystallized silicon carbide have been limited.

To afford semiconductive characteristics to recrystallized silicon carbide, NGK Insulators, Ltd., in Japanese Patent application No. 10-72644, disclosed that by controlling the firing atmosphere when recrystallizing silicon carbide, the resistance of the recrystallized silicon carbide can be increased. Although the method was quite effective, the problem of fluctuation in the resistance remained, depending on the number of shaped bodies in the fire-casing or the shaping position thereof. Moreover, there is a problem when SiC film is formed by a chemical vapor deposition on a surface of a substrate composed of a recrystallized silicon carbide and having a higher volume resistivity, in that the resistivity of the substrate is decreased to a value of not more than 50 Ω·cm.

### SUMMARY OF THE INVENTION

It is an object of the present invention to provide a recrystallized silicon carbide material having a large volume resistivity and a method for producing the same.

It is another object of the present invention to provide an anticorrosive member on a surface of the substrate by utilizing such a recrystallized silicon carbide, and a silicon carbide film having higher corrosion resistance and a lower electrical resistivity than that of the substrate.

The inventors have investigated the electrical resistance in recrystallized silicon carbides in detail. Consequently, they found that the resistivity of the recrystallized silicon carbide is dominated by low resistive layered carbon (C) generated on inner surfaces of open pores and, by removing the low resistive layer through etching, the recrystallized silicon carbide is enabled to have a higher resistance.

For example, they have successfully produced a recrystallized silicon carbide having a resistivity of not less than 10,000 Ω·cm by thermally treating it preferably at a temperature of not less than 100° C. while dipped in a mixed solution of acid, which removes the low resistive layered carbons on the inner surfaces of the open pores.

Every kind of acid can be used if it penetrates into the open pores of the recrystallized silicon carbide and etches the inner wall surfaces of the open pores. It is preferable, however, that a solution of the above acid contains at least hydrofluoric acid. In this case, it is desirable that the acid solution is a mixed solution of hydrofluoric acid and nitric acid, or a mixed solution of hydrofluoric acid, nitric acid, and sulfuric acid.

An etching temperature is preferably not less than 100° C., more preferably not less than 150° C.

The recrystallized silicon carbide preferably has the following characteristics:

(1) A porous sintered body having an amount of impurities of not more than 0.5 wt % (except Si and C), and a relative density of 80% to 90%; and

(2) A porous sintered body having an amount of impurities of not more than 2.0 wt % except Si and C and a relative density of not less than 70%.

The pre-etched recrystallized silicon carbide can be produced by a normal method, in which a shaped body is formed from powdered silicon carbide raw materials by casting, etc., and thereafter thermally treated at a temperature of 2200° C. to 2400° C., for example, whereby the recrystallized silicon carbide can be obtained.

This invention also relates to a highly resistive recrystallized silicon carbide with open pores having a resistivity of not less than 100,000 Ω·cm at room temperature, in which an amount of impurities (except Si and C) is not more than 0.2 wt %, and layered carbons on the inner surfaces of the open pores are removed.

The inventors also have investigated many kinds of firing methods for attaining even higher resistivity. Consequently, they found that by heating a shaped body from room temperature to a given temperature range of 1600° C. through 2000° C., under a pressure of not more than 0.01 atm, introducing an inactive gas up to a pressure of 0.5 atm to 2 atm, and thereafter heating the resulting material to a temperature in a range of 2200° C. to 2400° C., the recrystallized silicon carbide is highly purified. Further, thermally treating the highly purified-recrystallized silicon carbide at a temperature of not less than 100° C. while immersed in a mixed acidic solution, removes the low resistive layered carbons, thereby producing recrystallized silicon carbide having a resistivity of not less than 100,000 Ω·cm at room temperature.

In that case, it is preferable to heat the shaped body from room temperature to a temperature in a range of 1600° C. through 2000° C., at a pressure of not more than 0.01 atm, thereafter introduce an inactive gas to a pressure of 0.5 atm to 2 atm, evacuate up to a pressure of not more than 0.01 atm, introduce the inactive gas up to a pressure in a range of 0.5 atm to 2 atm, and thereafter heat the resulting material to a temperature in a range of 200° C. to 2400° C.

Furthermore, the inventors have conceived an anti-corrosive member, comprising a substrate made of a highly resistive recrystallized silicon carbide and a film of silicon carbide having a resistivity at room temperature of 20 Ω·cm to 500 Ω·cm, covering a surface of the substrate which is exposed to a corrosive substance.

In the case of heating a liquid, such as an extrapure water or a sterilized water, to prevent contamination, it is sometimes heated by a heater covered with a Teflon resin. Concretely, it is known that the surface of the stick-like, metallic heat-generating body is also coated with Teflon and put into a container with a solution, or that the inner wall surface of a container is coated with Teflon and the container is heated from outside. Recently, in addition to extrapure water and sterilized water, a super highly pure corrosive solution containing a mixture of hydrofluoric acid, nitric acid, hydrochloric acid, aqua regia, or the like have been required to be heated without any contamination of metallic ions or organic substances.

The purity of the silicon carbide film is preferably not less than 99.9999%. The thickness of the substrate is preferably not less than 8 mm.

The silicon carbide film is preferably highly purified and composed of a perfectly dense body having a theoretical density which is unlikely to be corroded with various solutions. In the anti-corrosive member according to this invention, an entire surface portion of the substrate to be contacted with a solution is covered with a highly pure and dense silicon carbide film, so that the substrate containing a large amount of impurities does not contact the solution. Therefore, contamination of the heated solution is very little and almost negligible. Consequently, the contamination degree of the solution can be decreased to a level under the ppt demanded for extrapure water. Moreover, the corrosion rate of the above silicon carbide film is very slow, so that is characteristics can be kept good for a long time. Since the surface of the film which contacts a corrosive substance is directly heated, the heating efficiency of the corrosive substance is higher.

Since the silicon carbide film contacting the corrosive substance is controlled to the resistivity of 20 Ω·cm to 500 Ω·cm, a voltage can be applied to the film. Thus, without a special means to a power supply, the film has an adequate heat-generating value as a heater. If the resistivity of the silicon carbide film is smaller than 20 Ω·cm, excessive current is required, which makes the size of the power supply larger and requires special parts such as a thyristor. If the resistivity is larger than 500 Ω·cm, the current to the electrode is so small that the film does not work as a heater.

In the case of induction-heating the corrosive substance, if the resistivity is smaller than 20 Ω·cm, the substrate sometimes suffers from destruction due to thermal shock generated by rapid heating, and if the resistivity is larger than 500 Ω·cm, the heat generating value becomes so small that the corrosive substance can not be heated.

The anti-corrosive member according to the present invention has an advantageously high heating efficiency, capable of heating the corrosive substance uniformly, because heat is generated at the plane of the film, of which resistivity is controlled uniformly. Large variations of the resistance-distribution of the silicon carbide film cause current concentrations in positions having a low resistance, whereby the contact portion of the heat-generating part of the film is decreased relatively, so that the heat-generating efficiency of the film degrades.

For the above corrosive substance, the above-mentioned corrosive solution is preferable. In applications such as semiconductor-manufacturing, for example, dense parts to be exposed to a reactive plasma gas are required. Reactive plasma gases such as CF₄, NF₃, CiF₃, HF, HCl, or HBr are highly corrosive. Accordingly, a part to heat the above intensely corrosive gas in an airtight container is required, and the anti-corrosive member can be applied as such a part.

### BRIEF DESCRIPTION OF THE DRAWINGS

For a better understanding of this invention, reference is made to the attached drawings, wherein:

FIG. 1 is a schematic view showing the equipment for etching recrystallized silicon carbide of Experiment A;

FIG. 2 is a schematic view to explain the measuring method for volume resistivity; and

FIG. 3 is a schematic view showing the equipment for the etching treatment of the recrystallized silicon carbide in Experiment B.

### DETAILED DESCRIPTION OF PREFERRED EMBODIMENTS

### Example

(Experiment A)

As a starting material, 45 parts by weight of coarse-powdery silicon carbide with the average particle size of 100 μm and 55 parts by weight of fine-powdery silicon carbide with the average particle size of 2 μm were mixed, and thereafter 20 parts by weight of water and 2 parts by weight of binder were added to obtain a slurry. The slurry was poured into a plaster mold with a dimension of 100 mm by 100 mm, and having a depth of 20 mm, and a shaped body was formed having a density of 2.6 g/cc and a porosity of 20%.

The thusly shaped body was heated to 2200° C. and held at the same temperature for 2 hours under Ar atmosphere of 1 atm pressure, in a high temperature-atmospheric furnace (carbon furnace), to obtain a sintered body of recrystallized silicon carbide.

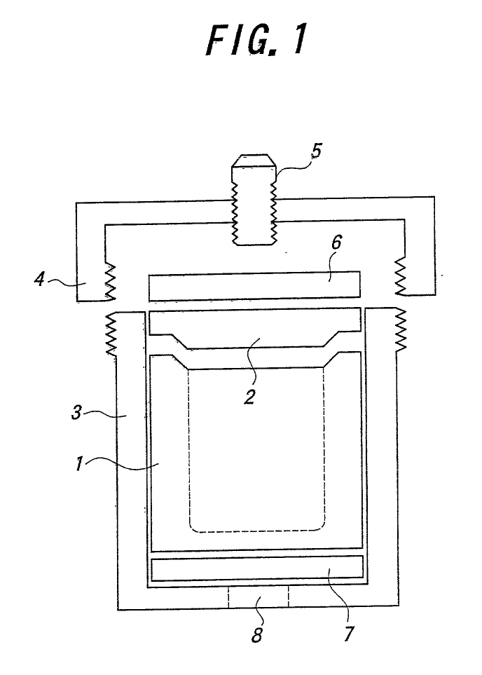

Six cc of hydrofluoric acid, 5 cc of nitric acid, and 4 cc of hydro-sulphuric acid were mixed and 15 cc of water was added to obtain a solution of the mixed acid. A rectangular parallelpiped sample with a dimension of 3 mm×4 mm×40 mm was cut out of the above sintered body. Then, the sample was dipped into the solution of mixed acid in a container 1 and the container 1 was accommodated into a container 3 as shown in FIG. 1, and thermally treated at 150° C. for 16 hours.

In FIG. 1, the container 1 made of Teflon is accommodated into the holding container 3 made of stainless steel and a lid 2 made of Teflon is fitted into the container 1 of Teflon. A lower board 7 is laid below the container 1 and a hole 8 to release a gas is provided below the lower board 7. An upper board 6 is set on the lid 2. The sample is accommodated into the container 1 of Teflon with the solution of the mixed acid, the lid 2 is fitted, the upper board 6 is set. Then, a lid 4 made of stainless steel is fitted to the container 3, the upper board 6 being pressed down by a tightening bolt, and thereafter the sample is heated.

The etching temperature of the solution of mixed acid was changed as shown in Table 1, and the holding time at each temperature of etching was 16 hours. The above sample before etching (Comparative Example 1) and each sample shown in Table 1 was measured with respect to a volume resistivity at room temperature. The thus obtained results are given in Table 1.

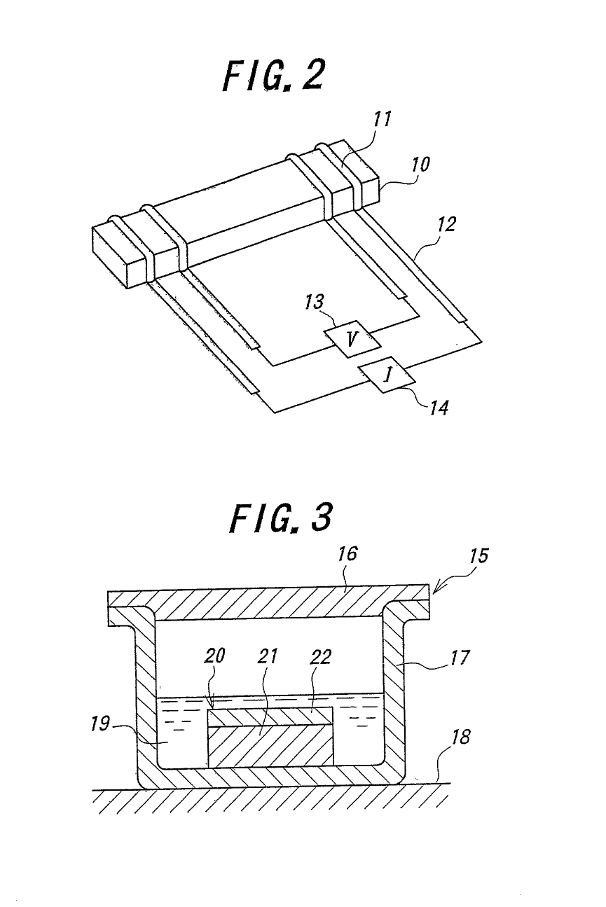

In measuring the volume resistivity, as shown in FIG. 2, a rectangular parallelpiped sample 10 with a dimension of 3 mm×4 mm×40 mm was cut out of each of the sintered bodies. Then, conducting wires 12 made of platinum were wound around four positions of the sample 10 and connected to an ammeter 14 and a voltmeter 13, and the electric resistivity of each of the above samples was measured by a four probe method. To ensure conduction between the sample 10 and the conducting wires 12, a platinum paste 11 was applied between the conducting wires and the surface of the sample. A constant current flow was applied between the two outer conducting wires (current terminals) of the four conducting wires 12, and at this time, the voltage between two inner conducting wires (voltage terminals) was measured. The measurement was carried out in a room kept at 20° C. An electrical resistivity was calculated from the following equation:

Electric resistivity=(the width of the sample×the thickness of the sample×the voltage)/(the distance between the voltage terminals×the current)

TABLE 1

| | | Temperature at | Volume resistivity at |
|---|---|---|---|
| | Acid | acid etching | room temperature |
| | etching | (° C.) | Ω · cm |
| Example 1 | etched | 150 | 20000 |
| Example 2 | etched | 100 | 11000 |
| Example 3 | etched | 200 | 22000 |
| Comparative | not etched | — | 5 |
| Example 1 | | | |

As the results show, the volume resistivity at room temperature of the recrystallized silicon carbide according to the present invention's treatment was remarkably increased. The solution of the mixed acid penetrated into the open pores of the recrystallized silicon carbide in Example 1 to Example 3 and the inner wall surfaces of the open-pores were etched. The temperature in the above etching is preferably not less than 100° C., more preferably 150° C. to 200° C.

(Experiment B)

Similar to Experiment A, a shaped body was formed, and thereafter accommodated into a firing furnace having an interior volume of 1000 liters and an effective volume of 200 liters (an interior volume of a casing made of carbon). Then, the furnace was heated up to a temperature of 2300° C. in 14 hours under a pressure of 1 atm and held at the same temperature for 5 hours with Ar gas flowing at a rate of 30 liters/min, and thereby a sintered body of a recrystallized silicon carbide was produced. The resistivity at room temperature of the thus obtained sintered body was 2000 Ω·cm.

Next, the sintered body of recrystallized silicon carbide was set into CVD equipment, and film-forming was carried out at a temperature of 1430° C. for 5 hours employing, as gas sources, silicon tetrachloride gas and methane gas. A rectangular parallelpiped sample, 3 mm×4 mm×40 mm, was cut out of the recrystallized silicon carbide layer in the thus obtained CVD-SiC/recrystallized silicon carbide-laminate. Then, the resistivity at room temperature of the sample was measured. The thus measured results are given in Table 2 (Comparative Example 2).

Six cc of hydrofluoric acid, 5 cc of nitric acid, and 4 cc of sulfuric acid were mixed and 15 cc of water was added to obtain a solution of the mixed acid. As shown in FIG. 3, the layered body 20 composed of the CVD-SiC film 22 and the substrate 21 of recrystallized silicon carbide was dipped into the solution 19 of the mixed acid and accommodated into a container body 15 shown in FIG. 3. The container 15 is made of Teflon, composed of a body 17 and a lid 16, and the laminate 20 is accommodated in the container with the solution 19 of the mixed acid. The container 15 was set on a hot plate 18 and heated at a temperature of 150° C. 16 hours. A rectangular parallelpiped sample measuring 3 mm×4 mm×40 mm was cut out of the substrate of the recrystallized silicon carbide in the laminate after thermal treatment. Then, the resistivity at room temperature of the sample was measured. The thus obtained results are listed in Table 2. Moreover, the volume resistivity at room temperature of the CVD-SiC film after etching was 40 Ω·cm.

TABLE 2

| | | Volume resistivity at |
|---|---|---|
| | | room temperature |
| | Acid Etching | (Ω · cm) |
| Example 4 | Etched | 50000 |
| Comparative Example 2 | not etched | 30 |

(Experiment C)

Similar to Experiment A, a shaped body was formed and thereafter accommodated into a carbon furnace. After the interior of the furnace was vacuum-evacuated up to a pressure of not more than 0.01 atm, heating was started. When the interior was heated to a temperature of 2000° C., Ar gas was introduced into the furnace up to a pressure of 1 atm. After the introduction of Ar gas, the interior was heated to a temperature of 2200° C. and held at the same temperature for 5 hours, to obtain a sintered body of recrystallized silicon carbide. The resistivity at room temperature of the thus obtained sintered body was 5,300 Ω·cm (Comparative Example 3).

A rectangular parallelpiped sample measuring 3 mm×4 mm×40 mm was cut out of the sintered body of above Comparative Example 3. Then, the sample was dipped into the same mixed acidic solution as that of Experiment A and thermally treated at a temperature of 150° C. for 16 hours. The resistivity at room temperature of the thermally treated sample was 210,000 Ω·cm (Example 5).

(Experiment D)

Similar to Experiment C, the sintered body of recrystallized silicon carbide of Comparative Example 3 was formed. A CVD-SiC film was formed on the sintered body by a similar way to Experiment B, and thereby a laminate composed of the CVD-SiC film and a substrate of the recrystallized silicon carbide was obtained. A rectangular parallelpiped sample measuring 3 mm×4 mm×40 mm was cut out of the substrate in the layered body. The resistivity at room temperature of the sample was 50 Ω·cm (Comparative Example 4).

The remainder of the laminate after cutting out the sample was etched by a similar way to Experiment B. A rectangular parallelpiped sample, of 3 mm×4 mm×40 mm, was cut out of the substrate of the recrystallized silicon carbide in the etched layered body. The resistivity at room temperature of the sample was 170,000 Ω·cm (Example 6).

(Experiment E)

Similar to Experiment A, a shaped body was formed and thereafter accommodated into a carbon furnace. After the interior of the furnace was vacuum-evacuated up to a pressure of not more than 0.01 atm, heating was started, and, when the interior was heated to a temperature of 2000° C., Ar gas was introduced into the furnace up to a pressure of 1 atm. After the introduction of Ar gas, heating was started again, and the interior was held at a temperature of 2300° C. for 5 hours, to obtain a sintered body of recrystallized silicon carbide. The resistivity at room temperature of the thus obtained sintered body was 7,400 Ω·cm (Comparative Example 6).

A rectangular parallelpiped sample measuring 3 mm×4 mm×40 mm was cut out of the sintered body. Then, the sample was dipped into the same solution as that of Experiment A and heated at a temperature of 150° C. for 16 hours. The resistivity at room temperature of the thermally treated sample was 10,000,000 Ω·cm (Example 7).

As mentioned above, according to the present invention, a recrystallized silicon carbide with a large volume resistivity and a method for producing the same can be provided. Moreover, an anti-corrosive member made of highly resistive recrystallized silicon carbide having a silicon carbide film on a surface thereof can be provided, wherein the silicon carbide film exhibits high corrosion resistance and smaller volume resistivity than the substrate surface.

1. A highly resistive recrystallized silicon carbide having open pores, wherein layered carbons on the inner wall surfaces of said open pores are removed and a resistivity at room temperature of said recrystallized silicon carbide is not less than 10000 Ω·cm.

2. A highly resistive recrystallized silicon carbide having open pores, wherein an amount of impurities except Si and C in said recrystallized silicon carbide is not more than 0.2 wt %, layered carbons on the inner wall surfaces of said open pores are removed, and a resistivity at room temperature of said recrystallized silicon carbide is not less than 100000 Ω·cm.

3. An anti-corrosive member, comprising a substrate made of a highly resistive recrystallized silicon carbide defined as claim 1 or 2 and a film of silicon carbide having a resistivity at room temperature of 20 Ω·cm to 500 Ω·cm, and covering that surface of the substrate which is exposed to at least corrosive substance.

4. A method for producing a highly resistive recrystallized silicon carbide, comprising the steps of preparing a material composed of a recrystallized silicon carbide having open pores, thermally treating the material in a state of dipping it in a solution of acid and thereby etching the inner wall surfaces of the open pores.

5. A producing method of a highly resistive recrystallized silicon carbide defined as claim 4, wherein the acid contains at least hydrofluoric acid.

6. A producing method of a highly resistive recrystallized silicon carbide defined as claim 5, wherein the acid contains hydrofluoric acid and nitric acid.

7. A producing method of a highly resistive recrystallized silicon carbide defined as claim 6, wherein the acid is a mixed solution of hydrofluoric acid, nitric acid, and sulfuric acid.

8. A producing method of a highly resistive recrystallized silicon carbide defined as any one of claims 4 to 7, wherein the temperature of the thermally treating is not less than 100° C.

9. A producing method of a highly resistive recrystallized silicon carbide defined as any one of claims 4 to 7, wherein the material is obtained by the steps of forming a shaped body, heating the shaped body to a temperature in a range of 1600° C. through 2000° C. from a room temperature at a pressure of not more than 0.01 atm, thereafter introducing an inactive gas to a pressure in a range of 0.5 atm to 2 atm and the heating the resulting material to a temperature in a range of 2200° C. through 2400° C.

10. A producing method of a highly resistive recrystallized silicon carbide defined as any one of claims 4 to 7, wherein the material is obtained by the steps of forming a shaped body, heating the shaped body to a temperature in a range of 1600° C. through 2000° C. from a room temperature at a pressure of not more than 0.01 atm, thereafter introducing an inactive gas to a pressure of 0.5 atm to 2 atm, evacuating up to a pressure of not more than 0.01 atm, introducing the Inactive gas up to a pressure in a range of 0.5 atm to 2 atm, and thereafter heating the resulting material to a temperature in a range of 2200° C. to 2400° C.

11. A method for producing an anti-corrosive member as defined in claim 3, comprising the steps of preparing a material made of recrystallized silicon carbide having open pores, thermally treating the material in a state of dipping it in a solution of acid and thereby etching the inner wall surfaces of the open pore, to obtain the substrate.

12. A producing method of an anti-corrosive member as defined in claim 11, comprising the steps of preparing a material made of recrystallized silicon carbide having open pores, forming a film of silicon carbide with a resistivity at room temperature of 20 Ω·cm to 500 Ω·cm, by CVD, on at least surface of the material to be exposed to corrosive substance to obtain a laminate, heating the laminate in a state of dipping it in a solution of acid, and thereby etching the inner wall surfaces of the open pores.

13. A producing method of an anti-corrosive member claimed in claim 12, wherein the material is obtained by the steps of forming a shaped body, heating the shaped body to a temperature in a range of 1600° C. through 2000° C. from a room temperature at a pressure of not more than 0.01 atm, thereafter introducing an inactive gas to a pressure in a range of 0.5 atm to 2 atm and heating the resulting material to a temperature in a range of 2200° C. through 2400° C.

14. A producing method of an anti-corrosive member defined as claim 12, wherein the material is obtained by the steps of forming a shaped body, heating the shaped body to a temperature in a range of 1600° C. through 2000° C. from a room temperature at a pressure of not more than 0.01 atm, thereafter introducing an inactive gas to a pressure of 0.5 atm to 2 atm, evacuating up to a pressure of not more than 0.01 atm, introducing the inactive gas up to a pressure in a range of 0.5 atm to 2 atm, and thereafter heating the resulting material to a temperature in a range of 2200° C. to 2400° C.

15. A producing method of an anti-corrosive member defined as any one of claims 11 to 14, wherein the acid contains at least hydrofluoric acid.

16. A producing method of an anti-corrosive member claimed in claim 15, wherein the acid contains hydrofluoric acid and nitric acid.

17. A producing method of an anti-corrosive member claimed in claim 16, wherein the acid is a mixed solution of hydrofluoric acid, nitric acid, and sulfuric acid

18. A producing method of an anti-corrosive member claimed in any one of claims 11 to 14, wherein the temperature of the thermally treating is not less than 100° C.
